(19) United States
(12) Patent Application Publication
(10) Pub. No.: US 2006/0289442 A1
(43) Pub. Date: Dec. 28, 2006

(54) Microwave Oven Cleaner

(76) Inventor: John-Paul Francis Cherry, Missouri City, TX (US)

Correspondence Address: JOHN-PAUL F. CHERRY, 3203 OAK BOUGH LN., MISSOURI CITY, TX, 77459-4655, US

(21) Appl. No.: 11/462,722

(22) Filed: Aug. 7, 2006

Related U.S. Application Data
(63) Continuation of application No. 10/701,336, filed on Nov. 4, 2003, now Pat. No. 7,087,871.
Application No. 10/701,336 is a continuation of application No. 09/923,511, filed on Aug. 7, 2001, now Pat. No. 6,656,288.
(60) Provisional application No. 60/225,709, filed on Aug. 16, 2000.

(51) Int. Cl. A21B 1/00; A21B 1/22; F27D 11/00

(52) U.S. Cl. 219/413

(57) ABSTRACT

Embodiments provide apparatuses and methods for cleaning microwave devices, such as microwave ovens. In one example, the apparatus may contain an enclosure at least partially enclosing a cleaning solution and a wiping article. The cleaning solution may contain water, a surfactant, and a fragrance, and the enclosure may contain a seal that may be separated to enable dispersion of the cleaning solution into a microwave oven interior. In another example, a microwave device and apparatus for cleaning the microwave device is provided which includes a region partially surrounded by at least one interior surface within the microwave device, a microwave energy source coupled to and positioned to radiate the region, a residue adhered to the at least one interior surface of the microwave device, an enclosure having at least one wall and contained within the region, and a first protective material for absorbing excess microwave energy contained within the enclosure.

### CROSS-REFERENCE TO RELATED APPLICATIONS

This application is a continuation of co-pending U.S. Ser. No. 10/701,336, filed Nov. 4, 2003, and soon to issue as U.S. Pat. No. 7,087,871, which is a continuation of U.S. Ser. No. 09/923,511, filed Aug. 7, 2001, and issued as U.S. Pat. No. 6,656,288, which claims benefit of U.S. Ser. No. 60/225,709, filed Aug. 16, 2000, which are herein incorporated by reference in their entirety.

### BACKGROUND OF THE INVENTION

Food residue is often found coating the inside of microwave ovens, especially industrial, commercial and educational settings. Over time, the accumulation of the food produces an unsightly mess that is also difficult to clean, as the material is repeatedly dehydrated to aggressively adhere to the surface. Attempts to scrub away the particulate by conventional method (i.e., abrasive sponge with soap and water) are time-consuming and may damage the plastic walls of the microwave. The process is also difficult because the worse part of the mess is often on the top of the oven, the area that is the hardest to see and clean. While microwave ovens have become symbolic of being quick and easy to use, the same is not true of cleaning them.

This problem has been noticed and several patents have been issued applying alternative solutions.

### PRIOR ART

Several patents have been issued to address this problem. U.S. Pat. Nos. 4,481,395 and 5,290,985 keep the walls of the microwave oven clean by placing inserts into the oven, relying on conventional cleaning methods (washing, scrubbing, drying) to be used when the insert is removed. A dishwasher may be used, if one is around. Also, these devices consume some of the usable volume inside the oven.

In U.S. Pat. Nos. 4,633,052 and 4,778,968, non-flammable, pre-sized paper is used to cover the floor of microwave oven. Once the paper becomes soiled, it is thrown out and replaced with a new sheet. Though these patents protect the floor, the walls and ceiling are overlooked. The ceiling generally accumulates the majority of the food debris while being the more difficult area to clean.

Furthermore, each of the above-mentioned patents necessitate the device to be custom-dimensioned (in as many as three axes) for use in each different size of microwave oven. This represents a significant limitation.

Other inventions have realized this problem of soiling a microwave oven and have attempted preventive solutions. These inventions, such as U.S. Pat. Nos. 4,721,140 and 5,436,434, use splatter guards to minimize the expulsion of food material onto the inner surfaces of the oven.

U.S. Pat. Nos. 4,560,850, 5,313,878, 5,432,324, and 5,558,798 have been issued for releasing steam or moisture for the use of cooking or steaming food. Also, U.S. Pat. Nos. 3,753,651 and 4,861,956 address the sterilization of surfaces, of items brought into the oven, by the use of microwave radiation and/or steam. All of the above mentioned patents ignore cleaning the interior of the microwave oven.

It is therefore desirable to have a simple, quick, low-cost means of cleaning a microwave oven that saves effort to clean the oven while not disturbing normal microwave activities. Moreover, the power of the oven should be utilized to clean itself. The device should not require customization or resizing to work in different sizes of microwave ovens. All materials should be non-toxic, so any residues would not pose a threat to health.

### SUMMARY OF THE INVENTION

In one embodiment of the invention, a cleaning device contains (in its simplest form) an open cell container used to hold a non-toxic, aqueous solution that may contain surfactant(s) such as TERGITOL® 15-S-9, d-limonene and/or an emulsifier such as ethoxylated-soybean oil. Details are provided below. The method of use is to place the device into the microwave oven that is then turned on for approximately five minutes, followed by a period of an additional five minutes while the oven door remains closed, allowing the solution to penetrate the caked-on material. The door is then opened. Food residues, which previously held aggressively to the interior of the oven, may be thoroughly wiped clean with a soft sponge or towel. Many residues fall off. The invention works impressively well.

There are four factors to the efficaciousness of the invention: 1) the vapor phase of the solution, created by heating with microwave energy, has a direct effect of softening the residue by steaming; 2) the surfactant is borne by the vapor phase of the solution to the residue at any location in the oven, where it bonds to any remaining oils; 3) the “cool-down” period allows the solution to leave the vapor phase, condense and penetrate more deeply into the residue, also carrying surfactant deeper inside; 4) the wiping down phase, in which the heated solution remaining in the device is used to wipe down the surfaces of the oven. During the vapor phase, any fragrance or scent is distributed throughout the room in which the oven resides. The result is a highly efficacious, low cost, non-toxic, microwave oven cleaning method. The volume of solution used for a cleaning must be sufficiently small so that it will boil for a predominance of the on-time of the oven (during cleaning), in the range of 80-100 mL. The volume of the solution must be in accord to the cooking time and concentration of surfactant. Though some of the surfactant will be borne onto the interior surfaces of the oven, much will remain dissolved in the solution of the reservoir. The surfactant will slow the loss of water in the reservoir; therefore, maintaining a protective material for excess microwave energy.

In the solution, the surfactants are non-toxic, making the invention safe in the event any residues are left after the cleaning process. Scent such as lemon or pine may be added to produce a pleasant smell. Antibacterial compounds may be added without degrading the effectiveness of the process.

Several embodiments are disclosed for an open-cell container including: a simple dispenser with a tear-off membrane seal; a sponge that is soaked with solution; an integrated dispenser and sponge with a tear-off cover; an integrated dispenser and sponge in which the solution is released by penetrating the sponge; a dispenser with a fill line and sponge; and a dispenser with an attached bottle hanger and sponge.

### BRIEF DESCRIPTION OF THE DRAWINGS

FIG. 1 shows a section through a microwave oven cleaner device made of a dispenser with a tear-off membrane seal containing the cleaning solution.

FIG. 2 shows a microwave oven cleaner device with the solution in a sponge.

FIG. 3 shows a section through a microwave oven cleaner device including a dispenser with a tear-off membrane seal and an integral clean-up sponge.

FIG. 4 shows a section through a microwave oven cleaner device including a dispenser with a cut through membrane seal and an integral clean-up sponge.

FIG. 5A shows a section through a microwave oven cleaner device made of a dispenser, solution, sponge and fill-line.

FIG. 5B shows the perspective of looking down into a microwave oven cleaner device of FIG. 5A.

FIG. 6A shows a section through a microwave oven cleaner device made of a dispenser, solution, sponge, fill line and attached bottle hanger.

FIG. 6B shows a side-view of a microwave oven cleaner device of FIG. 6A.

### DETAILED DESCRIPTION OF THE DRAWINGS

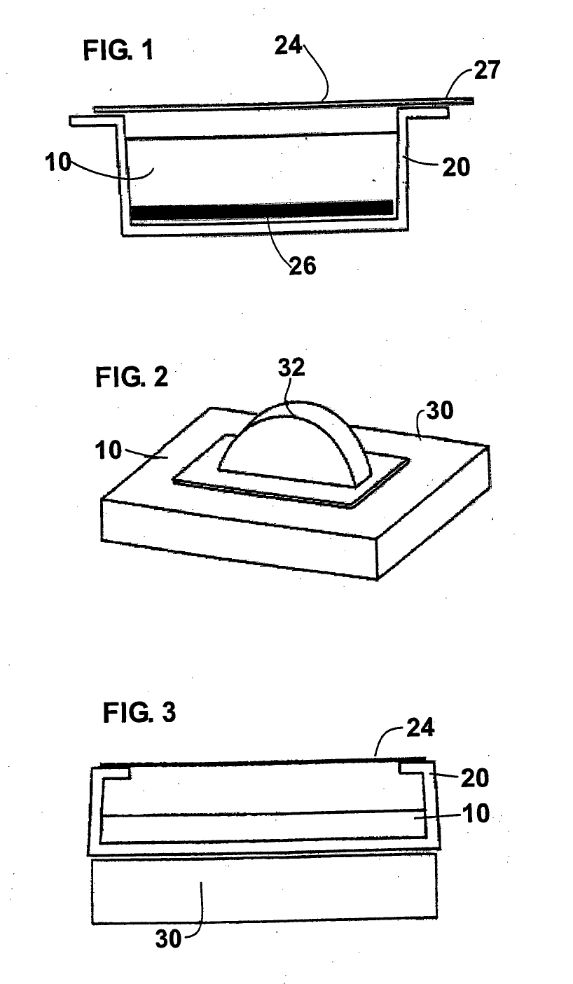

FIG. 1 shows the solution 10 in a disposable dispenser 20 with a tear-off membrane seal 24. To open, tear tab 27. A gelatinous material 26 prevents damage to the microwave if solution 10 is boiled away well before heating cycle ends, preventing damage to the oven.

The dispenser 20 with tear-off membrane seal 24 maintains solution 10 until time of use. Once the seal 24 is pierced or removed, the apparatus is placed into the microwave oven and activated by running the oven. The vapor phase has now started. During this phase, a portion of solution 10 will vaporize and leave the dispenser 20. Surfactant is borne by the vapor phase of solution 10 to the residue at any location in the oven, where it bonds to any remaining oils. An interval to condense allows the solution 10 to leave the vapor phase and penetrate more deeply into the residue, carrying surfactant deeper inside. The wiping down phase is achieved by pouring the remaining heated solution 10 from dispenser 20 and wiping down the interior surfaces of the oven with a sponge, cloth, paper towel, shammy or similar item.

The preferred solution for this embodiment contains approximately, by volume, 96% water, 2% d-limonene and 2% E-Z-MULSE®, an ethoxylated soybean-oil emulsifier (ingredients available from Florida Chemical Co.). d-Limonene is a non-toxic, citrus scent that also enhances performance due to its surfactant properties. Another embodiment uses a blend surfactant, such as a 1% solution containing 40% TERGITOL® 15-S-9 and 60% TERGITOL® 15-S-15, (available from Union Carbide) in an aqueous base. Emulsifiers may be used to aid surfactants while dissolving in the aqueous solution. A non-blend embodiment uses TRITON® X301, also from Union Carbide. Antibacterial agents, such as triclosan, or other additives, such as ammonia, are also obvious to include as an option. Surfactant concentrations in the range of 0.5% to 50% are also obvious to include as an option.

While a microwave oven operates, substances containing water, generally food, absorb microwave energy. Excess microwave energy will destroy a microwave oven. Concentration of dissolved surfactant may be altered such to slow the rate of evaporation of solution 10 and allow the absorption of excess microwave energy. The gelatinous material 26 also absorbs excess energy and may be used with solution 10 to curtail dehydration of solution 10. The collaborative effort of solution 10 and the gelatinous material 26 produces a larger, therefore safer, interval to operate and clean the oven than solution 10 alone.

The dispenser 20 could be made from a variety of materials including plastic, paper, cardboard, glass, ceramic or other microwave-safe materials.

FIG. 2 shows solution 10 soaked in a sponge 30 with a plastic handle 32 attached by prongs that penetrate the sponge 30. The sponge is packaged in such a way to prevent drying of the sponge 30 (i.e., plastic wrap found on traditional single wrapped sponges).

The sponge 30 would be removed from plastic wrap just prior to using and placed into the oven. The vapor phase has begun once the oven is started. During this phase, a portion of solution 10 will vaporize and leave the sponge 30. Surfactant is borne by the vapor phase of solution 10 to the residue at any location in the oven, where it bonds to any remaining oils. An interval to condense allows the solution 10 to leave the vapor phase and penetrate more deeply into the residue, carrying surfactant deeper inside. The wiping down phase is achieved by using the sponge 30, and the remaining heated solution 10 inside of sponge 30, to wipe off the interior surfaces of the oven. The device may also be produced with the surfactant in the sponge and sold in a dehydrated state, reducing weight to save on shipping cost. The product would be wetted prior to use. The handle 32 may be omitted.

FIG. 3 shows a disposable dispenser 20 with a tear-off membrane seal 24 containing the solution 10 and a sponge 30 integrated into the back of the dispenser 20.

The dispenser 20 with tear-off membrane seal 24 maintains solution 10 until time of use. Once the seal 24 is pierced or removed, the apparatus is placed into the microwave oven and activated by running the oven. The vapor phase has now started. During this phase, a portion of solution 10 will vaporize and leave the dispenser 20. Surfactant is borne by the vapor phase of solution 10 to the residue at any location in the oven, where it bonds to any remaining oils. An interval to condense allows the solution 10 to leave the vapor phase and penetrate more deeply into the residue, carrying surfactant deeper inside. The wiping down phase is achieved by pouring the remaining heated solution 10 from dispenser 20 and wiping down the interior surfaces of the oven with attached sponge 30.

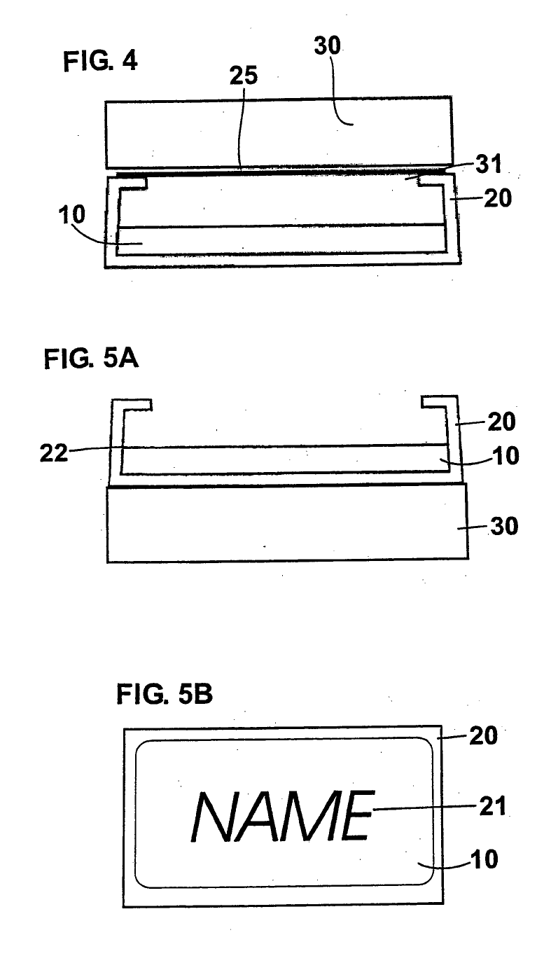

FIG. 4 shows a sponge 30 attached to the open face 31 of disposable dispenser 20. A cut through membrane 25 lies between sponge 30 and disposable dispenser 20. The product may be opened with a fork or knife plunged into sponge 30 and through membrane 25. This allows the sponge 30 to be wetted with solution 10 that may be volatile, such as ammonia, yet stored. The dispenser 20 may be shaped as a handle. A heavy surfactant can be used in the solution 10 in this embodiment.

The dispenser 20 with membrane seal 25 maintains solution 10 until time of use. Once the seal 25 is pierced and the solution 10 moistens the sponge 30, the apparatus is placed into the microwave oven and activated by running the oven. The vapor phase has now started. During this phase, a portion of solution 10 will vaporize and leave the sponge 30. Surfactant is borne by the vapor phase of solution 10 to the residue at any location in the oven, where it bonds to any remaining oils. An interval to condense allows the solution 10 to leave the vapor phase and penetrate more deeply into the residue, carrying surfactant deeper inside. The wiping down phase is achieved by holding the dispenser 20 and wiping down the interior surfaces of the oven with attached sponge 30.

FIG. 5A shows a dispenser 20 with solution 10 and attached sponge 30. Such dispenser could be filled with solution 10 at time of use. A fill line 22 is used to define the preferred volume of solution 10 to be added. The attached sponge 30 is optional.

At time of use, the dispenser 20 is occupied with solution 10 at a preferred volume marked by the fill line 22. The apparatus is placed into the microwave oven and activated by running the oven. The vapor phase has now started. During this phase, a portion of solution 10 will vaporize and leave the dispenser 20. Surfactant is borne by the vapor phase of solution 10 to the residue at any location in the oven, where it bonds to any remaining oils. An interval to condense allows the solution 10 to leave the vapor phase and penetrate more deeply into the residue, carrying surfactant deeper inside. The wiping down phase is achieved by pouring the remaining heated solution 10 from dispenser 20 and wiping down the surfaces of the oven with sponge 30, cloth, paper towel, shammy or similar item.

FIG. 5B shows the same device as in FIG. 5A; however, this view is that from above looking down into a dispenser 20 with solution 10. From this perspective, an insignia 21 is noticeable.

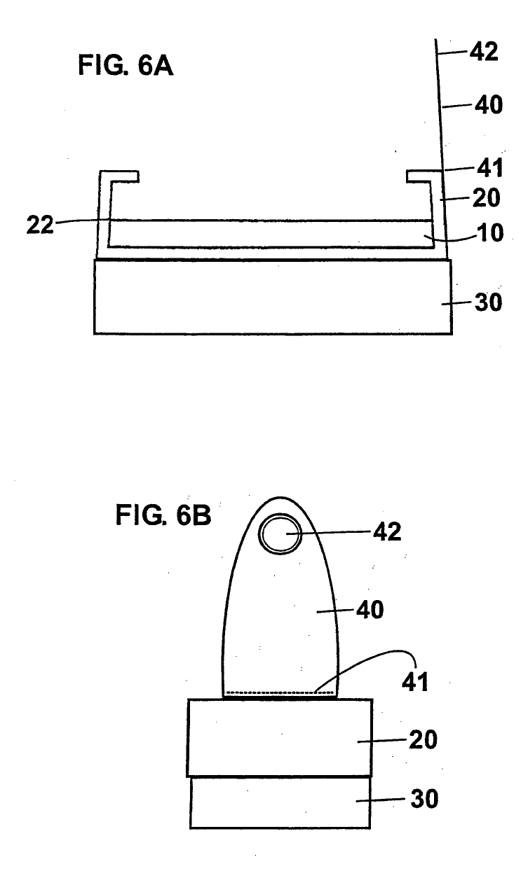

FIG. 6A shows solution 10 in a disposable dispenser 20 with sponge 30 and an attached bottle hanger 40. The bottle hanger 40 is composed of a fold or perforation 41 and a hole 42 to place over the top of a bottle when stored or distributed for resale. The bottle hanger 40 may be torn off from dispenser 20 via perforated fold 41 without affecting performance of the device. A fill line 22 is used to define the preferred volume of solution 10 to be added. The attached sponge 30 is optional.

At time of use, the dispenser 20 is occupied with solution 10 at a preferred volume marked by the fill line 22. The apparatus is placed into the microwave oven and activated by running the oven. The vapor phase has now started. During this phase, a portion of solution 10 will vaporize and leave the dispenser 20. Surfactant is borne by the vapor phase of solution 10 to the residue at any location in the oven, where it bonds to any remaining oils. An interval to condense allows the solution 10 to leave the vapor phase and penetrate more deeply into the residue, carrying surfactant deeper inside. The wiping down phase is achieved by pouring the remaining heated solution 10 from dispenser 20 and wiping down the interior surfaces of the oven with sponge 30, cloth, paper towel or similar item.

FIG. 6B shows the same device of FIG. 6A turned by a 90-degree perspective to one side. Solution 10 is in a disposable dispenser 20 with an attached bottle hanger 40. Bottle hanger 40 is composed of an optional fold or perforation 41 and a hole 42 to place over the top of a bottle.

While the principles of the invention have been made clear in illustrative embodiments, there will be immediately obvious to those skilled in the art, many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, within the limits of the true spirit and scope of the invention.

1. An apparatus for cleaning a microwave oven interior, comprising:
a wiping article for effecting a cleaning process;
a cleaning solution comprising water, a non-toxic surfactant, and a fragrance; and
an enclosure at least partially enclosing the cleaning solution and the wiping article, wherein the enclosure comprises a seal that upon separating at least a portion of the seal, the cleaning solution is enabled to be dispersed into the microwave oven interior.

2. The apparatus of claim 1, wherein the enclosure comprises plastic and the seal is breakable, severable, separable, or tearable.

3. The apparatus of claim 2, wherein the cleaning solution is compatible with food preparation.

4. The apparatus of claim 1, wherein the wiping article is a cloth, a soft towel, or a paper towel.

5. The apparatus of claim 4, wherein the enclosure comprises plastic or paper.

6. The apparatus of claim 5, wherein the cleaning solution further comprises an emulsifier, an antibacterial agent, or combinations thereof.

7. The apparatus of claim 5, wherein the fragrance comprises a scent selected from the group consisting of lemon, citrus, and pine.

8. The apparatus of claim 1, wherein the cleaning solution provides a heated cleaning liquid and a cleaning vapor upon being heated by a microwave oven.

9. The apparatus of claim 1, wherein the enclosure comprises a plastic wrap, the wiping article is a soft towel, and the fragrance comprises a citrus scent.

10. An apparatus for distributing a fragrance and for cleaning an interior surface of a microwave oven, comprising:
a wiping article for effecting a cleaning process;
a cleaning solution contained within the wiping article, wherein the cleaning solution comprises water, a surfactant, and a fragrance;
a plastic-containing wrap positioned and sealed around the wiping article and the cleaning solution to maintain the wiping article moist prior to use; and
a sealed side of the plastic-containing wrap that is separable for enabling fluid communication between the cleaning solution and outside of the enclosure.

11. The apparatus of claim 10, wherein the wiping article is a soft towel and the fragrance comprises a citrus scent.

12. The apparatus of claim 10, wherein the sealed portion of the plastic-containing wrap is breakable, severable, separable, or tearable.

13. The apparatus of claim 10, wherein the surfactant is a non-toxic surfactant and the cleaning solution is compatible with food preparation.

14. The apparatus of claim 10, wherein the wiping article is a cloth, a soft towel, or a paper towel.

15. The apparatus of claim 10, wherein the sealed side of the plastic-containing wrap is an upper surface of the plastic-containing wrap.

16. The apparatus of claim 14, wherein the cleaning solution further comprises an emulsifier, an antibacterial agent, or combinations thereof.

17. The apparatus of claim 14, wherein the fragrance comprises a scent selected from the group consisting of lemon, citrus, and pine.

18. The apparatus of claim 10, wherein the cleaning solution provides a heated cleaning liquid and a cleaning vapor upon being heated by a microwave oven.

19. A method for cleaning surfaces within a region of a microwave device, comprising:
providing an interior surface comprising a residue adhered thereon within the microwave device;
providing an enclosure positioned within the microwave device, wherein the enclosure comprises at least one wall substantially surrounding a first protective material comprising water;
exposing the enclosure to microwave energy to clean the residue from the interior surface;
absorbing excess microwave energy with the first protective material; and
loosening the residue adhered on the interior surface.

20. The method of claim 19, wherein the first protective material comprises water.
